(19) United States
(12) Patent Application Publication
(10) Pub. No.: US 2017/0045728 A1
(43) Pub. Date: Feb. 16, 2017

(54) SYSTEMS AND METHODS FOR AN OPTICAL SYSTEM WITH AN ADJUSTABLE PROJECTED FOCAL PLANE

(71) Applicant: Novartis AG, Basel (CH)

(72) Inventors: Mauricio Jochinsen, Fountain Valley, CA (US); Vadim Shofman, Irvine, CA (US); Lingfeng Yu, Rancho Santa Margarita, CA (US)

(21) Appl. No.: 14/825,224

(22) Filed: Aug. 13, 2015

(51) Int. Cl. G02B 21/36; G02B 21/00

(52) U.S. Cl. CPC G02B 21/364; G02B 21/0012; G02B 21/361; G02B 21/362

(57) ABSTRACT

An optical system configured to display a composite image includes a projection system that overlays a projected image onto a projected image plane. The optical system further includes at least two eyepieces through which the composite image is viewable to a user and a lens system having a subject image plane viewable through the at least two eyepieces. The subject image plane includes a subject image. The projection system causes the projected image to appear on a projected image plane, viewable through the at least two eyepieces, to include the projected image and the subject image in the composite image. The projection system further includes an adjustable optical component that is adjustable to position the projected image plane relative to the subject image plane.

### TECHNICAL FIELD

The present disclosure is directed to methods and systems for medical procedures, and more particularly, to methods and systems involving imaging for such procedures.

### BACKGROUND

Many microsurgical procedures require precision cutting and/or removal of various body tissues. For example, in ophthalmic microsurgical procedures inner limiting membrane (ILM) removal and epi-retinal membrane (ERM) removal are useful surgical treatments of different macular surface diseases. However, the surgical techniques for ILM and ERM peeling require skill and patience. In the ophthalmic context and in other microscopic surgical contexts, precise and carefully constructed surgical instruments are used for each aspect of the surgical technique.

To aid the operator with these types and other types of surgical procedures, operators may use an imaging system that presents a microscope subject view of the tissue to be treated, such as a view of the tissue of the patient's eye. Accordingly, the user of such an imaging system may be provided with a close-up view of the surgical instruments, such as forceps or other tools, as well as the region of the eye that is of interest. In some cases, the operator may also be provided with additional information that may be useful to the operator. For example, the operator may be presented with additional information in an overlaid display, visible through the eyepieces of the microscope. However, overlaid images can block or obscure the view of the microsurgical site. Additionally, the overlaid images may visually compete with the view of the microsurgical site for the attention of the surgeon. In some instances, the overlaid images may be missed by the surgeon if the images are not displayed to the surgeon's dominant eye. In other instances, the images may be too distracting when displayed to the surgeon's dominant eye. Accordingly, there is a need for continued improvement in the use and operability of surgical systems and tools for various ophthalmic procedures and/or other microscope-assisted procedures.

### SUMMARY

The present disclosure is directed to exemplary optical systems configured to display a composite image and may include at least two eyepieces through which the composite image is viewable to a user. An exemplary optical system may further include a lens system having a subject image plane viewable through the at least two eyepieces. The subject image plane may include a subject image, such as an image of tissue to be treated or observed. The optical system may further include a projection system that overlays a projected image onto a projected image plane, viewable through the at least two eyepieces, thereby including the projected image and the subject image in the composite image. The projection system may include an adjustable optical component, wherein a position of the projected image plane is adjustable relative to the subject image plane by adjustment to the adjustable optical component.

Exemplary microscopes may include a left eyepiece and a right eyepiece through which a composite image is viewable to a user and may also include a lens system having a subject image plane viewable through the left and right eyepieces. The subject image plane may include a subject image. Such an exemplary microscope may also include a projection system that overlays a projected image onto a projected image plane to include the projected image and the subject image in the composite image. The projection system may further include a projected image source to provide the projected image, an adjustable optical component coupled to an adjusting component, such as a kinematic mount, to enable surgeon-controlled positioning of the adjustable optical component, and a beam coupler configured to combine the subject image and the projected image into the composite image. A position of the projected image plane may be adjustable relative to the subject image plane by adjustments to the positioning of the adjustable optical component.

Exemplary projection systems may include a projected image source to insert or introduce a projected image into a subject image path. Such exemplary projection systems may further include a beam splitter and an adjustable optical component. The beam splitter may split the projected image into a left eyepiece projected image along a left projected image path toward a left eyepiece and a right eyepiece projected image along a right projected image path toward a right eyepiece. The projection system may include an adjustable optical component, wherein a position of a projected image plane relative to a subject image plane is adjustable by positioning and/or orienting the adjustable optical component. The projection system may further include an adjusting component coupled to the adjustable optical component to enable controlled positioning of the adjustable optical component. The projection system may also include a left beam coupler and a right beam coupler to combine at least one of the left eyepiece projected image and the right eyepiece projected image into the subject image path to generate a composite image.

It is to be understood that both the foregoing general description and the following detailed description are exemplary and explanatory in nature and are intended to provide an understanding of the present disclosure without limiting the scope of the present disclosure. In that regard, additional aspects, features, and advantages of the present disclosure will be apparent to one skilled in the art from the following detailed description.

### BRIEF DESCRIPTION OF THE DRAWINGS

The accompanying drawings illustrate embodiments of the devices and methods disclosed herein and together with the description, serve to explain the principles of the present disclosure.

FIG. 1 illustrates a perspective view of an exemplary surgical system, according to an embodiment consistent with the principles of the present disclosure.

FIG. 2 is an illustration of an exemplary block diagram of the surgical system of FIG. 1, according to an aspect consistent with the principles of the present disclosure.

FIG. 3 is a diagram illustrating a subject image path of a surgical microscope, according to aspects of the present disclosure.

FIG. 4 is a diagram illustrating a projected image path through a surgical microscope, according to aspects of the present disclosure.

FIG. 5 is a diagram illustrating a subject image path and a projected image path combined in a composite image path in a surgical microscope, according to aspects of the present disclosure.

FIG. 6 is a side view diagram of the microscope of FIG. 5, according to aspects of the present disclosure.

FIG. 7 is a diagram of a user perspective of a composite image provided by features shown in FIGS. 3-6, according to aspects of the present disclosure.

FIGS. 8A and 8B are top view diagrams of embodiments of a microscope as in FIG. 5, according to aspects of the present disclosure.

FIG. 9 illustrates a projection system for a microscope configured within a housing, according to aspects of the present disclosure.

FIG. 10 is a flowchart of a method of providing an adjustable projected image focal plane to a user of a microscope, according to aspects of the present disclosure.

The accompanying drawings may be better understood by reference to the following detailed description.

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of the disclosure is intended. Any alterations and further modifications to the described devices, instruments, methods, and any further application of the principles of the present disclosure are fully contemplated as would normally occur to one skilled in the art to which the disclosure relates. In particular, it is fully contemplated that the features, components, and/or steps described with respect to one embodiment may be combined with the features, components, and/or steps described with respect to other embodiments of the present disclosure. For simplicity, in some instances the same reference numbers are used throughout the drawings to refer to the same or like parts.

The present disclosure is directed to methods and systems for displaying additional information relating to a surgical procedure along with a standard subject image of a surgical site. In various procedures, a user may observe a region of interest, such as a particular tissue region at a surgical site, by using an imaging system, including a microscope. The imaging system may also include a projected image system to include a display of additional surgical data to the user in connection with the image of the region of interest shown by the optics of the microscope. In one example, an informational peripheral data display region or frame about a central surgical viewing area may be projected into a subject image path of the microscope to permit the user to view the surgical site and the additional information. As such, the surgeon may continue to perform the surgery while visually being made aware of changing states or measured parameters during the surgery. The projected image system may provide for interactive virtual buttons to be displayed to the user's view.

In another example, the additional surgical data includes an OCT image. For example, some imaging systems include a microscope imaging system and an OCT imaging system. The OCT imaging system obtains an OCT image that includes a cross-sectional view of the region of interest. Thus, the OCT image may be used to visualize tissue below the outer surface tissue. In some cases, the OCT image or another pre-operative image or image set is provided as a surgical data overlay within the microscope image. In yet another example, a zoomed-in view of the subject image obtained by the microscope is projected into the image path to provide a standard view and a zoomed-in view. The additional information, interface elements, and/or images provided to the user through the microscope may increase the quality and efficiency of the surgery, benefiting both the surgeon and the patient.

In order to prevent the projected images from obstructing the surgeon's view or from posing a distraction to the surgeon during a procedure, the principles of the present disclosure enable the projected image to appear as if on a different visual plane than the subject image obtained from the microscope. Accordingly, when the surgeon is focused on the subject image, the projected image may not appear in focus. In this way the information is presented to the surgeon in a way that does not obstruct the surgeon's view and that decreases the distraction posed by the overlaid information. The surgeon may be able to adjust the separation distance between the subject image plane and the projected image plane and to adjust the relative brightness of images included in each visual plane. Additionally, the surgeon may be able to select one side of the stereoscopic microscope in which to include the projected image, according to the particular surgeon's dominant eye and personal preferences. The non-selected side of the stereoscopic microscope may block the projected image or provide a relative decrease in the intensity of that side compared to the selected side.

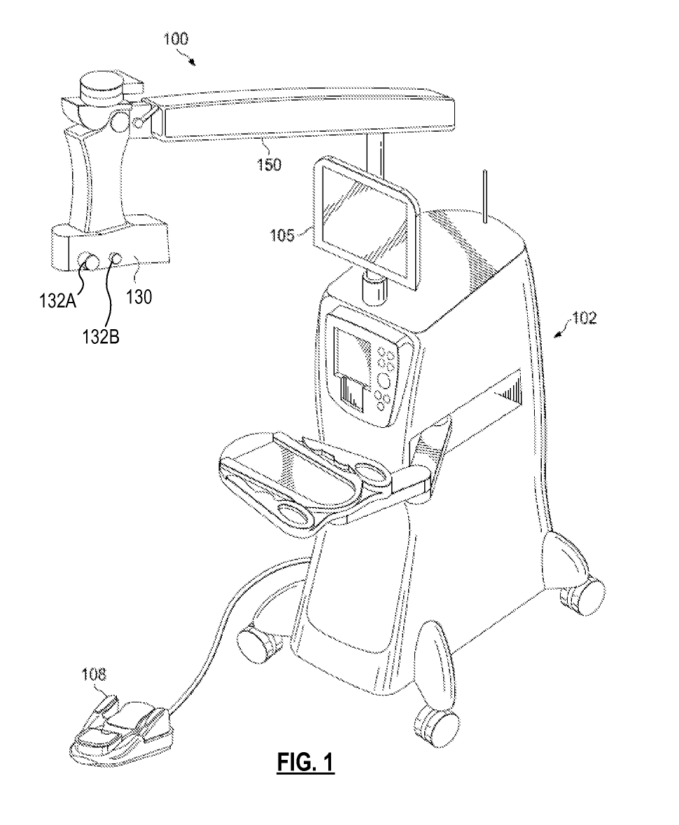

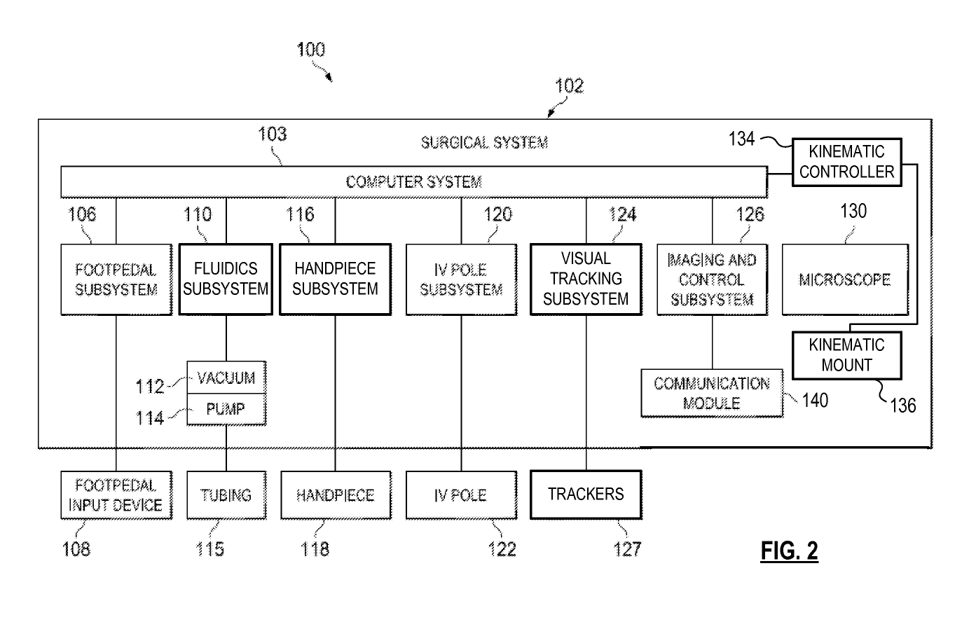

FIG. 1 shows an exemplary surgical system 100 for treating a condition. As illustrated in FIG. 1, the surgical system 100 is specially configured for treating ophthalmic conditions. Other embodiments may include adaptations and configurations particular to other types of conditions and other types of surgeries. In the embodiment shown, the surgical system includes a console 102 for performing a surgery and includes a microscope 130. The console 102 is a surgical console configured and arranged to perform a surgical procedure, such as an ocular surgical procedure on a patient. In one embodiment, the surgical console is a phacoemulsification surgical console. FIG. 2 is a block diagram of the surgical system 100 and includes the console 102 and the microscope 130.

The console 102 includes a computer system 103, a display screen 105, and a number of subsystems that are used together to perform ocular surgical procedures, such as emulsification or vitrectomy surgical procedures, for example, or ILM or ERM procedures. For example, the subsystems include a foot pedal subsystem 106 including, for example, a foot pedal input device 108, a fluidics subsystem 110 including an aspiration vacuum 112 and an irrigation pump 114 that connect to tubing 115, a handpiece subsystem 116 that may be an ultrasonic generator subsystem or a pneumatic vitrectomy cutter subsystem including a handpiece 118 (which may be an ultrasonic handpiece or a vitrectomy handpiece or other instrument, in various embodiments), an intravenous (IV) pole subsystem 120 including a motorized IV pole 122, a tracking subsystem 124 including one or more trackers 127 (cameras located in the eyepieces and/or other tracking hardware, such as a radiofrequency tracking system or an electromagnetic tracking system), and an imaging and control subsystem 126 including a communication module 140. Other tools may be included additionally or alternatively in other embodiments. In this example, a microscope 130 and an arm 150 (FIG. 1) also form a part of the console 102. However in other embodiments, the microscope 130 and arm 150 are separate from the console 102, e.g., provided in separate housings. To optimize performance of the different subsystems during surgery, their operating parameters differ according to, for example, the particular procedure being performed, the different stages of the procedure, the surgeon's personal preferences, whether the procedure is being performed in the anterior or posterior portion of the patient's eye, and so on.

The different subsystems in the console 102 comprise control circuits for the operation and control of the respective microsurgical instruments and for the microscope 130. The computer system 103 may govern the interactions and relationships between the different subsystems to properly perform an ocular surgical procedure and to properly communicate information to the operator of the surgical system 100 through the microscope 130. To do this, the computer system 103 may include one or more processing devices, such as a central processor, and memory and be preprogrammed with instructions for controlling the subsystems to carry out a surgical procedure, such as an emulsification procedure or a vitrectomy or for ILM and ERM peeling, for example. Some of the instructions may cause methods and operations described herein to be performed by the central processor.

In addition, the console 102 includes an input device that permits a user to make selections within a limited scope to control or modify the preprogrammed relationships between different subsystems. In this embodiment, input devices may be incorporated into, or otherwise in communication with, the console 102 and may include the foot pedal input device 108, a touch screen device responsive to selections made directly on the screen, a standard computer keyboard, a standard pointing device, such as a mouse or trackball, buttons, knobs, or other input devices. Yet others are also contemplated, including, for example, a tool tracking subsystem that permits the surgeon to manipulate a virtual user interface using a tool, such as the tip of the handpiece 118. Using the input devices, a surgeon, scientist, or other user may select or adjust parameters that affect the relationships between the different subsystems of the console 102. Accordingly, based on a user input, a user may change or adjust the relationships from those that were hard-coded into the console by the system programmers.

Similarly, the user may change or adjust components of the microscope 130 to adjust a focal plane of an overlaid or projected image viewable to the user through eyepieces of the microscope. As shown in FIG. 1, the microscope 130 includes a first adjustment mechanism 132A and a second adjustment mechanism 132B, referred to collectively as adjustment mechanisms 132. For example, the adjustment mechanisms 132 may be knobs that are mechanically coupled to a kinematic mount 136 (FIG. 2) or another type of adjusting component that is configured to provide controllable physical translation along one or more axes and/or rotation around one or more of the axes. The kinematic mount 136 may be coupled to one or more adjustable components of the microscope 130, such as a mirror or a body having a mirrored surface thereon. As discussed herein, the adjustable component of the microscope 130 may be adjusted to move a focal plane of a projected image relative to a subject image plane, i.e. the focal plane of the microscope 130. In some embodiments, the surgical system 100 may include a kinematic controller 134 (FIG. 2) in communication with the computer system 103, such that the kinematic mount 136 or other adjusting component may be adjusted electronically in addition to, or as an alternative to, mechanical operation using the adjustment mechanisms 132. In some implementations, the adjusting component may include a plurality of servos that are controllable by the kinematic controller 134.

In the embodiment shown, still referring to FIG. 1, the arm 150 supports the microscope 130. As such, the microscope 130 may be attached to the console 102 and may be positioned at location proximate the surgical site so that a surgeon may view the surgical site, while performing a surgical procedure. By including overlaid images that communicate information to the surgeon or that permit receipt of input from the user by including virtual interface elements in the images, the efficiency of the operation may be increased because the surgeon need not take his eyes off the surgical site to obtain status information of the system or to enter commands.

The imaging and control subsystem 126 is configured and arranged to present data and information to the microscope 130 for easy and intuitive display to a surgeon during a surgical procedure. The imaging and control subsystem 126 may communicate with a projected image source to overlay an image into the image path of the microscope 130. As such, the surgeon can look through the microscope 130 to see the surgical environment while still obtaining the benefit of a data display. This may enable the surgeon to look through a microscope, grasp tools, manipulate a virtual user interface, etc., to maintain an optimal surgical experience. The communication module 140 of the imaging and control subsystem 126 may comprise a transceiver used to communicate with the microscope 130, in some embodiments. The communication module 140 may communicate settings and/or images relating to the surgical site and the console settings. Wired and wireless systems are contemplated.

Such an imaging system permits a user to observe both a conventional microscope image and a projected image while using a surgical instrument to perform an ophthalmic surgical procedure such as an ILM removal. The conventional microscope image is observed using light reflected off a subject, e.g., the retina of a patient, which then moves along an imaging path including a plurality of optical elements through one or more eyepieces of the microscope 130 to the eye or eyes of the surgeon. The surgeon may focus the microscope 130 at a subject image plane, e.g., the plane of the retina or another feature undergoing microscopic surgery. The projected image may include user interface elements that provide information about a patient, such as a pressure within the eye (intraocular pressure), information about a particular tool or about the subsystems of the system 100, such as a parameter or a status, and/or a reference image, such as a previously obtained optical image or an image obtained using another modality. Images obtained using another modality may include an optical coherence tomography image, a magnetic resonance image, or an image from yet another modality. The projected image may be a static image, a dynamic image, or may be a series of images or a video.

Generally, such surgical data overlays remain fixed in a viewable location with respect to the subject image as seen in the microscope 130. Thus, the user has to direct his or her vision away from regions of interest to view the surgical data overlay. This can be risky if the user is in the middle of a delicate procedure. The user may have to hold the tools steady while redirecting visual attention to the surgical data overlay. The microscope 130 includes components that allow the user to adjust the projected image plane relative to the subject image plane. In this way, when the surgeon's eyes are focused on the subject image plane, user interface elements projected into the image and pathway of the microscope 130 may appear out of focus. Because those elements and information are presented out of focus, elements and information included in the projected image may present a reduced distraction or obstruction to the surgeon whose attention and eyes are focused at the subject image plane, than when the projected image is project at the subject image plane.

According to principles described herein, the present disclosure is directed to facilitating the adjustment of a plane of a projected image of the surgical data/interface overlay relative to the subject image seen through the eyepieces of the microscope 130 in a subject image plane.

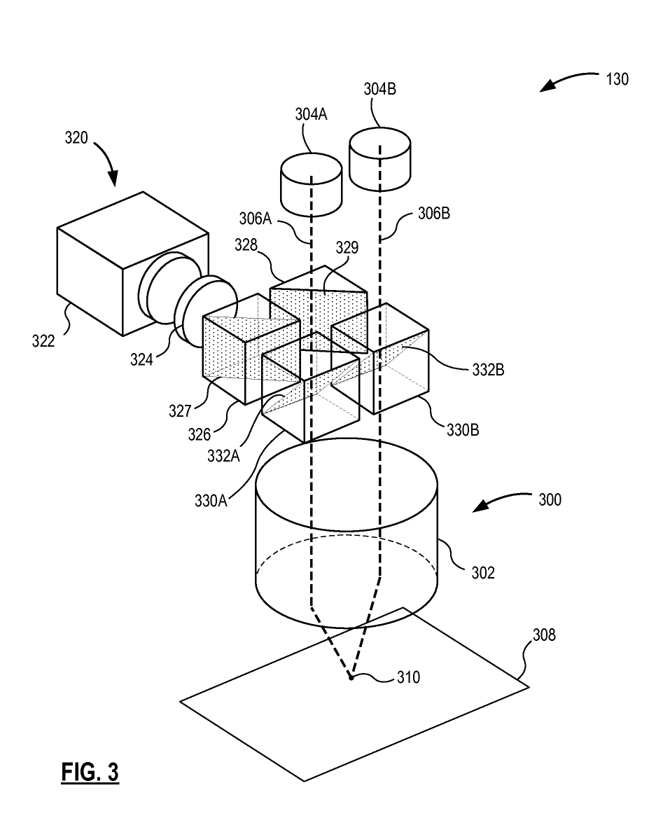

FIG. 3 is a diagram illustrating an imaging path of the microscope 130, according to aspects of the present disclosure. As illustrated, the microscope 130 includes a microscope lens system 300 and a projection system 320 to allow a projected image to be introduced into the imaging path of the microscope 130. The lens system 300 includes a plurality of microscope lenses 302, which may include a plurality of lenses as well as filters, mirrors, and or other optical elements used to magnify and focus an image of a subject for presentation to the surgeon. For example, the operations necessary to perform a corrective operation on the eye of a patient may require visualizing tissues, tools, and other features that are too small to be manipulated appropriately without the assistance of the microscope 130. The lens system 300 further includes two eyepieces 304A and 304B as illustrated in FIG. 3. These are collectively referred to as eyepieces 304 and include a right eyepiece 304A and a left eyepiece 304B. Some embodiments of the microscope 130 may include two eyepieces; while other embodiments thereof may include more than two eyepieces.

The lens system 300 includes an image path 306 to provide an image obtained at the subject image plane 308. As shown, the image path 306 includes a left eye image path 306A and a right eye image path 306B. Accordingly, the image path 306 provides stereoscopic imaging at the subject image plane 308. The lens system 300 may have a focus point 310 lying on the subject image plane 308.

In order to include a projected image in the image path 306, the microscope 130 further includes the projection system 320, an embodiment of which is illustrated in FIG. 3. The projection system 320 includes a projected image source 322, which may be a liquid crystal display or light emitting diode projector, or another comparable light producing image source. The projection system 320 further includes an optics component 324, which may be a plurality of optical components, such as filters and/or lenses, which are used to couple a projected image to a beam splitter 326. The beam splitter 326 has a beam splitting surface 327 that splits the light of the projected image into directions. A portion of the light of the projected image may travel straight through the beam splitter 326 while another portion of light of the projected image may be deflected or reflected off the beam splitting surface 327 at an angle away from the beam splitter 326. The reflected portion of the light of the projected image may next encounter an adjustable optical component 328 having a directable optical surface 329. The adjustable optical component 328 may be coupled to the kinematic mount 136, illustrated in FIG. 2. In some embodiments, the adjustable optical component 328 is coupled to another type of adjusting component to permit adjustment and movement of the adjustable optical component 328 in one or more degree of translational and/or rotational movement. In some implementations, the directable optical surface 329 may be a mirrored surface configured to reflect again the reflected portion of the light of the projected image. The light transmitted through the beam splitter 326 and the light reflected by the beam splitter 326 and the adjustable optical component 328 is included in the image path 306 by beam couplers 330A and 330B, respectively. The beam couplers 330A and 330B are referred to collectively as beam couplers 330. Each of the beam couplers 330 includes a coupling surface or coupling interface 332A and 332B, respectively.

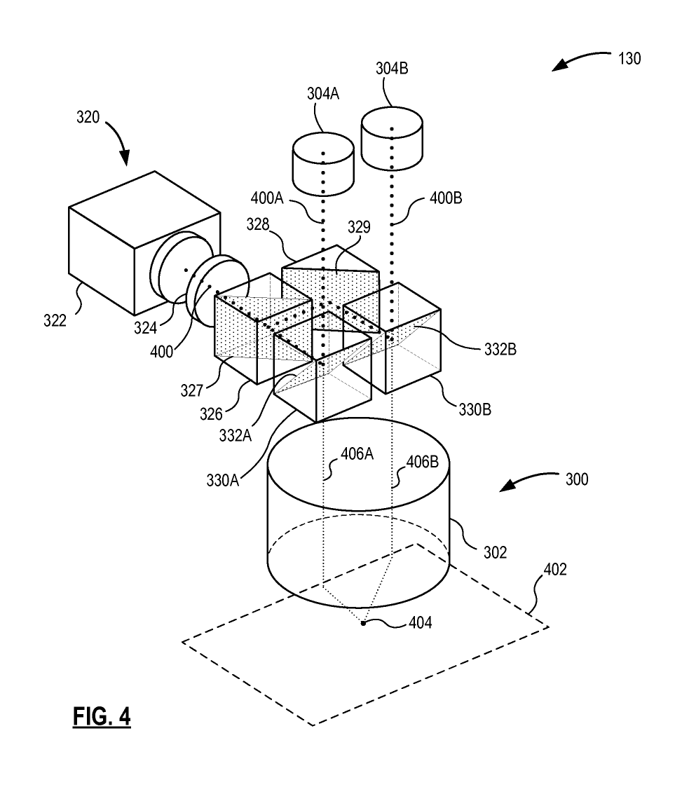

Referring now to FIG. 4, shown therein is another view of the microscope 130, including the lens system 300 and the projection system 320. FIG. 4 depicts a projected image path 400 that allows light from a projected image to be introduced into the subject image paths 306 of FIG. 3. The image path 400 includes respective left and right eye image paths 400A and 400B, respectively.

The light corresponding to the projected image leaves the projected image source 322 (also referred to as the projector 322) and passes through the optics components or optics component 324. In some embodiments, the optics component 324 includes or is an optical filter, such as a neutral density filter. Additionally, some embodiments of the microscope 130 include an image intensity attenuator, such as an electronic shutter or a mechanical shutter. Accordingly, the optics component 324 may reduce a visual intensity of the projected image relative to a subject image in the subject image path 306 by decreasing the intensity of the light of the projected image before it enters the beam splitter 326. In other embodiments, the optics component 324 may reduce a visual intensity of the subject image relative to the projected image.

The light corresponding to the projected image passes through the optics component 324 into the beam splitter 326. The light of the projected image, or simply the projected image, is split by the beam splitting surface 327 into a left eyepiece projected image along a left projected image path 400A and a right eyepiece projected image along a right projected image path 400B. The left projected image path continues through, or may be redirected through, the remainder of the beam splitter 236 and into the beam coupler 330A. The beam coupler 330A includes the coupling interface 332A, which redirects the light of the projected image into the subject image path 306A to the eyepiece 304A. As illustrated a portion of the light of the projected image is split by the beam splitting surface 327 and directed toward the adjustable optical component 328 and the directable optical surface 329 thereon. The light incident upon the directable optical surface 329 may reflect off the directable optical surface 329 at an angle equal to the angle of incidence upon the directable optical surface 329. The reflected light may form an angle that introduces an asymmetry between the right eyepiece projected image path 400B and the left eyepiece projected image path 400A. From the directable optical surface 329, the portion of the light of the project image travels to the beam coupler 330B where it is redirected into the subject image path 306B by the coupling interface 332B, which may be a reflective surface for light travelling from the directable optical surface 329, while being transmissive to light travelling from the lenses 302. From the coupling interface 332B, the light of the projected image travels to the eyepiece 304B.

As shown in FIG. 4, the projected image paths 400A and 400B between the beam couplers 330A and 330B and the eyepieces 304A and 304B are composite image paths that include both the subject image and the projected image in a composite image. The composite image may appear to a user as a microscope view with overlaid information relevant to the surgical procedure. For example, such as system data or system status information, physiological data or surgical status information, and/or user interface elements, like a virtual button. The composite image may include information on more than one image plane.

Due to the configuration of the beam splitter 326 and alignment differences in the adjustable optical component 328, the projected image may appear to the surgeon to be on a different plane than the subject image plane 308 of FIG. 3. As illustrated, the projected image plane 402 appears to the surgeon to be beneath the lenses 302 from the perspective of the eyepieces 304A and 304B as if originating according to the virtual image paths 406A and 406B. The focus point 404 of the projected image appears to lie on the projected image plane 402.

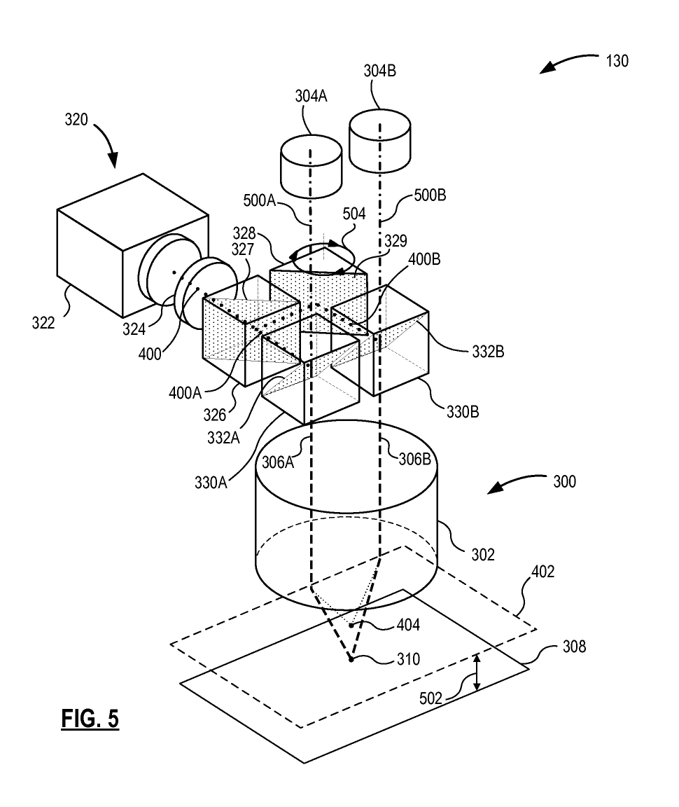

Referring now to FIG. 5, shown therein is a combination of the subject image path 306 of FIG. 3 and the projected image path 400 of FIG. 4 included together in a composite image path, e.g. an image path that includes both the projected image and the subject image. As shown in FIG. 5, the projected image path 400 and the subject image paths 306 combine in the composite image paths 500A and 500B, which provide light from the projected image source 322 and reflected light from the subject being observed through the microscope 130. The composite image paths 500A and 500B provide the user with a left side composite image and a right side composite image.

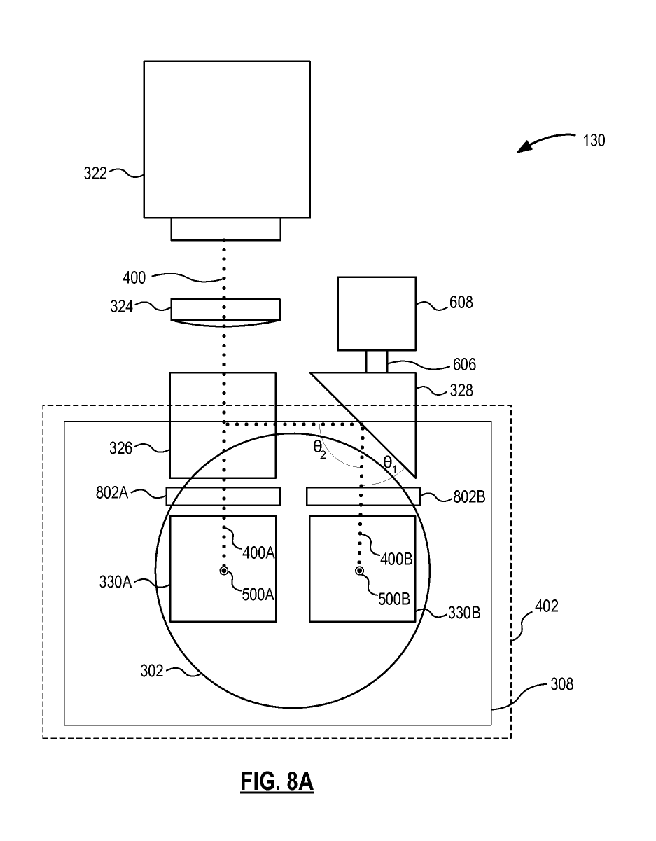

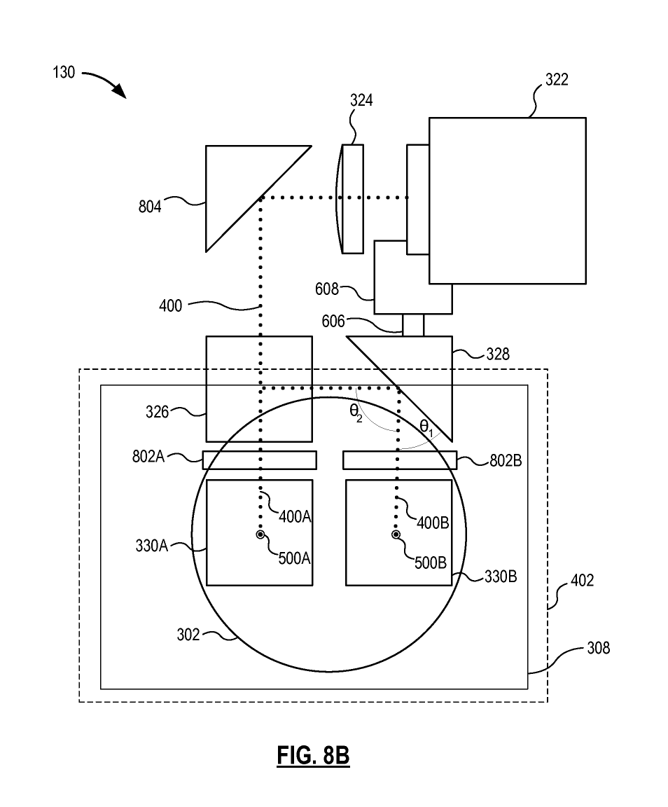

FIG. 5 further illustrates a perceived separation distance 502. The perceived separation distance 502 may be observed by a surgeon when viewing a subject through the eyepieces 304. By manipulating the alignment or configuration of the adjustable optical component 328 and the directable optical surface 329 thereon, a difference in the projected image paths 400A and 400B may be introduced. For example, the adjustable optical component 328 may be manipulated to reflect the projected image path 400B at an angle slightly off parallel to the projected image path 400A. The off-parallel angle of the projected image path 400B relative to the projected image path 400A may be interpreted by the visual cortex of the surgeon so as to make the projected image appear on the projected image plane 402 at a separation distance 502 away from the subject image plane 308. In other words, by adjusting an angle θ₁ (shown in FIGS. 8A and 8B) between the projected image paths 400A and 400B, a perception of depth relative to the subject being viewed through the microscope 130 may be introduced. The indicator 504 indicates one of several degrees of freedom of the adjustable optical component 328 that may be used to adjust the projected image plane 402. Further, by selectively adjusting the angle the perceived depth of the visual information included in the projected image path 400 relative to the subject may be adjusted.

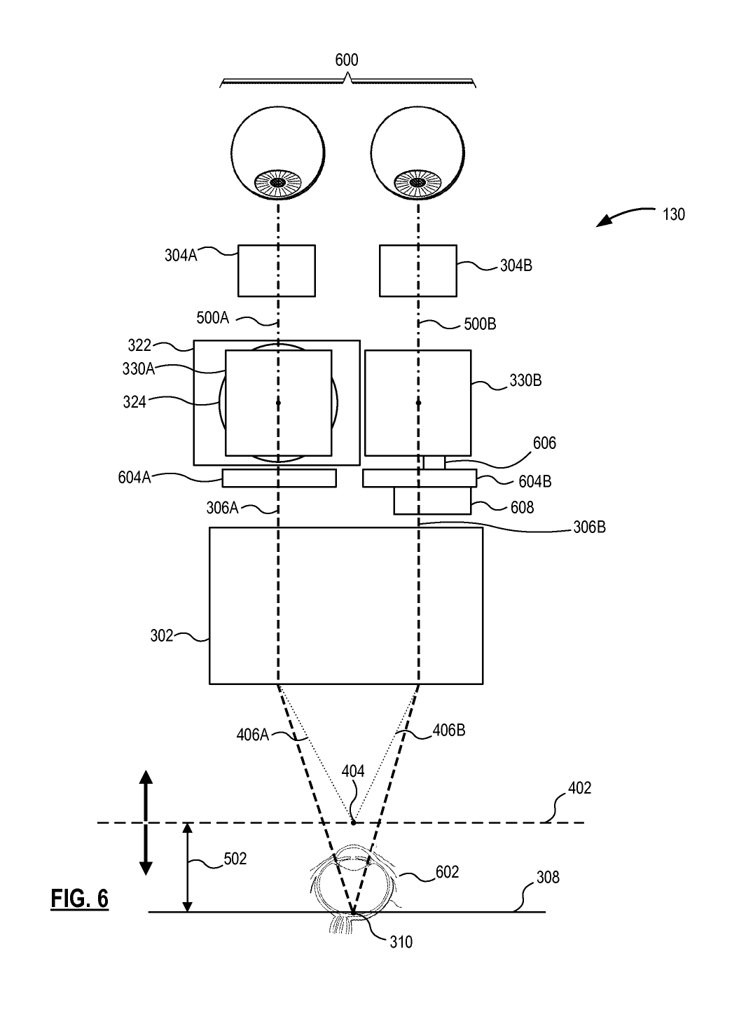

Referring now to FIG. 6, shown therein is a side view of the microscope 130. Many of the features illustrated in FIG. 6 are illustrated in FIGS. 2-5. FIG. 6 illustrates the lenses 302 and the eyepieces 304A and 304B, which provide a subject image to view through the microscope 130 to the eyes 600 of the user or surgeon. The eyepieces 304 may be adjusted to accommodate different surgeons, as the separation distance between eyes 600 of different surgeons or technicians may vary. The subject image paths 306A and 306B are illustrated in FIG. 6 and are depicted as having a focal plane shown as subject image plane 308 at the base of the patient's eye 602. Between the lenses 302 and the eyepieces 304, some embodiments of the microscope 130 include one or more attenuators 604A and 604B, together referred to herein as attenuators 604.

As illustrated in FIG. 6, the microscope 130 includes a left attenuator 604A and a right attenuator 604B. The attenuators 604 may provide control over light reflected off the subject image plane 308 toward the eyepieces 304. For example, if the surgeon prefers the subject image, i.e. the view of the back of the patient's eye 602, to be darker, the surgeon may manipulate the imaging and control subsystem 126 of the console 102 of FIG. 2. The imaging and control subsystem 126 may include mechanical and/or electrical controls for the attenuators 604. The attenuators 604A and 604B may be controlled independently of each other, and may include mechanical shutters or electrical shutters, such as a liquid crystal display (LCD) shutter. When the attenuators 604 are activated to decrease intensity of the light reflected from the subject image plane 308, the projected image provided by the projected image source 322 may appear relatively brighter than the subject image. This may allow the surgeon to better perceive information included in the projected image plane 402. In some embodiments, the microscope 130 may include an eye tracking system, as part of the tracking subsystem 124 or as part of the imaging and control subsystem 126 (FIG. 2), which may determine which plane, subject image plane 308 or projected image plane 402, the surgeon is focusing on. The imaging and control subsystem 126 may automatically adjust the attenuators 604 to emphasize whichever plane is focused upon at the time.

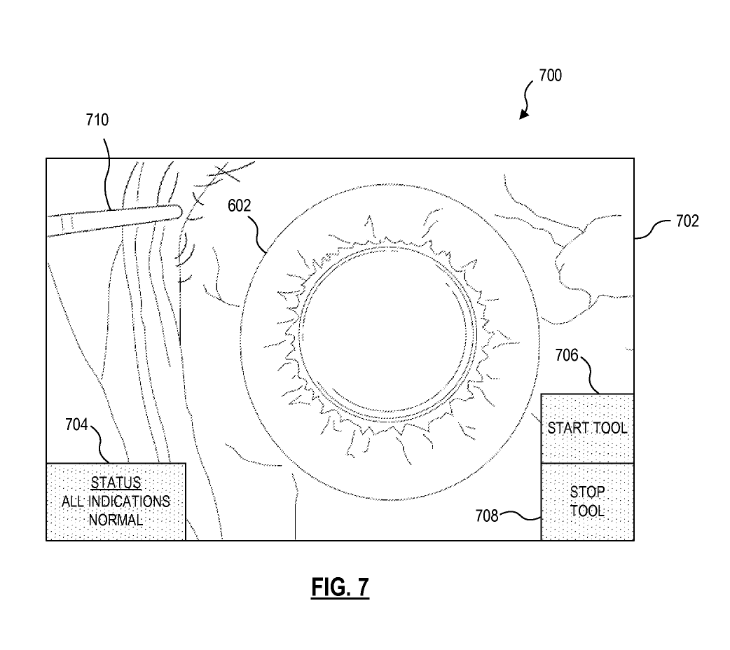

As illustrated in FIG. 6, the subject image plane 308 and the projected image plane 402 appear to the surgeon to be separated by a distance 502. The distance 502 may be adjusted by the surgeon to be greater than the diameter of the eye 602 such that any information included in the projected image appears to be outside and above the subject image plane 308. The projected image plane 402 may be adjusted to appear at or below the level of the subject image plane 308, as directed by the surgeon. Consequently, when one or more interactive user interface elements are included in the projected image, the surgeon will perceive those user interface elements to be a safe distance above the eye 602. For example, shown in FIG. 7 is a visualization 700 which shows a subject image 702 of the patient's eye 602. The visualization 700 also includes user interface elements introduced by the projected image source 322 into the imaging pathway viewed through the eyepieces 304. The user interface elements included in the projected image include a status window 704, an interactive start button 706, and an interactive stop button 708. Accordingly, the projected image shown in the visualization 700 includes interactive elements and non-interactive elements. To the user of the microscope, only one of the subject image and the projected image may appear in focus at a time given the separation distance 502 indicated in FIGS. 5 and 6. In some embodiments, the status window 704, start button 706, and stop button 708 may be made relatively transparent by adjusting the brightness of the projected image relative to the subject image. Additionally, the image projected by the projected image source 322 may be made digitally transparent by selectively removing some of the pixels from the image. The removed pixels permit the light from the subject image to reach the eyes 600 without additional information from the projected image, and so provide for transparent projected image elements. The degree of transparency can be adjusted by the imaging and control subsystem 126 by removing progressively more or fewer pixels from the image to be projected into the composite image paths 500A and 500B.

Some embodiments of the surgical system 100 may include a tool tracking subsystem, included as part of the tracking subsystem 124 or as part of or in combination with the imaging and control subsystem 126 (FIG. 2). The tool tracking subsystem may receive visual information, such as a video feed obtained through the microscope 130 in order to track one or more tools like the tool 710 shown in the visualization 700. Embodiments of the surgical system 100 that include the tool tracking subsystem may permit the surgeon to interact with the projected image, including the buttons 706 and 708, by manipulation of the tool 710. For example, when the surgeon holds the tool 710 at or above the projected image plane 402 and over the area occupied by the start button 706 or the stop button 708, the tool tracking subsystem may coordinate with the imaging and control subsystem 126 to register the surgeon's actions as a selection of either the start button 706 or the stop button 708. The tool tracking subsystem may not register any actions when the tool 710 of a tip thereof is not detected as being nearby or coincident with the projected image plane 402. In other words, the surgical system 100 may register interactions between the tool 710 and interface elements included in the projected image on the projected image plane 402 in order to permit control of one or more aspects of the surgical system 100 or to request additional or alternative information for display by the projected image source 322 into the imaging path of the microscope 130. By including the projected image at a separation distance 502 that appears to the surgeon to be above and outside the eye 602, the surgical system 100 may help to prevent unintentional interactions between the tool 710 and the eye 602 when a surgeon attempts to using the tool 710 to interact with an interface element.

Referring again to FIG. 6, shown there in is a coupling arm 606 that secures the adjustable optical component 328 to an adjusting component, such as the kinematic mount 608. The kinematic mount 608 may be configured to adjust the position and/or orientation of the adjustable optical component 328 in order to increase or decrease the separation distance 502 as desired by the surgeon. The kinematic mount 608 may provide for the adjustment of the orientation and position of the adjustable optical component 328 in space. Additionally, the kinematic mount 608 may allow for partial rotation of the adjustable optical component 328 around an x-axis, a y-axis, and/or a z-axis. For example, the indicator 504 of FIG. 5, illustrates rotation about an axis extending in the z-direction. In some embodiments, the beam splitter 326 may be coupled to another kinematic mount, like the kinematic mount 608. The beam splitter 326 may be adjustable in the x-direction, y-direction, and z-directions and able to rotate about one or more axes associated with those directions. As the adjustable optical component 328 is manipulated, the directable optical surface 329 redirects the portion of the projected image incident thereon. As the portion of the projected image is redirected off the axis parallel to the left imaging projected image path 400A, the projected image may appear to move closer to or further away from the surgeon and closer to or further away from the subject image plane 308.

The kinematic controller 134 of FIG. 2 may be coupled to the kinematic mount 608 to provide for electronic or mechanical adjustments. For example, the microscope 130 may include knobs 132 as seen in FIG. 1. Additionally or alternatively, the computer system 103 may interact with the kinematic controller 134 by transmitting electronic signals there to, which are interpreted by the kinematic controller 134 to manipulate the kinematic mount 608. The adjustments to the adjustable optical component 328 may provide an adjustable focal plane as described herein. By including multiple focal planes within a view provided by the eyepieces 304, the microscope 130 may include visual information in a way that is less distracting to the surgeon and may provide for safer virtual buttons like the buttons 706 and 708 of FIG. 7.

Referring now to FIGS. 8A and 8B, shown there in are top views of embodiments of the microscope 130. Both the views include attenuators 802A and 802B, collectively referred to as attenuators 802. The attenuators 802 may be operated individually, so that the brightness or intensity of the projected image path 400A may be equal to, less than, or greater than the brightness or intensity of the projected image path 400B, or vice versa. The attenuators 802 may be neutral density filters or a set of selectable neutral density filters, according to some embodiments. In other embodiments, the attenuators 802 may be electronic or mechanical shutters, or electronically adjustable attenuators such as a liquid crystal display (LCD) plate.

Many surgeons have a dominant eye that is more sensitive to the projected image than the other eye. If the projected image is included in the image path of the microscope 130 at too high an intensity, the projected image may be excessively distracting to the dominant eye of the surgeon. In some embodiments, the surgeon may interact with the computer system 103 to request that the projected image should be shown to only the surgeon's right eye or left eye, according to a preference of the surgeon. In such embodiments, the attenuators 802 may be selectively, individually activated to prevent the projected image from being transmitted through the eyepiece 304A or the eyepiece 304B. The imaging and control subsystem 126 may function as an attenuator control system to receive attenuator adjustment commands and command the attenuators 802 to effect the adjustments.

As illustrated in FIGS. 8A and 8B, the portion of the light of the projected image incident on the directable optical surface 329 of the adjustable optical component 328 may form an angle θ₁ of about 45 degrees with the light reflected off the directable optical surface 329. The kinematic mount 608 may be controlled to cause the angle θ₁, between the directable optical surface 329 and the reflected light, to be adjustable over a range of about ±10 degrees, such that the angle θ₁ can range from about 35 to 55 degrees. Accordingly, the angle θ₂ may be adjusted to be less than or more than 90 degrees.

Additionally, the kinematic mount 608 may be used to adjust the projected image path 400B into or out of the plane of drawing sheet of FIG. 8A. The deflection angle of the directable optical surface 329 changes by adjustments to the adjustable optical component 328. As the deflection angle θ₁ changes, the surgeon sees the projected image on his right eye shift, e.g., laterally right or left, while the projected image on the other (left) eye remains unchanged. As a result, this relative shift between left and right projected images may adjust the projected image plane 402 in the surgeon's perception into or out of the plane of drawing sheet of FIG. 8A, e.g., away from or toward the image plane 308. In other words, the adjustable optical component 328 may be manipulated to angle the projected image path 400B toward the eyepiece 304B or toward the lenses 302 in order to adjust the depth and/or focus of the projected image.

As shown in FIG. 8A, the projected image source 322 is aligned with the beam splitter 326 such that the projected image path 400 (before being split) is coincident with the projected image path 400A. In embodiments in which the beam splitter 326 is mounted on a kinematic mount and adjustable in multiple degrees of freedom, the beam splitter 326 may be adjusted such that the projected image path 400 and the left projected image path 400A are not coincident. In embodiments according to FIG. 8B, the projected image source 322 may be disposed at an angle to the projected image path 400A extending between the beam splitter 326 and the beam coupler 330A. Such embodiments may include an optical component 804 to redirect the imaging projected image path 400 toward the beam splitter 326. For example, the optical component 804 may be a mirror placed in the projected image path 400 to angle the light thereof toward the beam splitter 326.

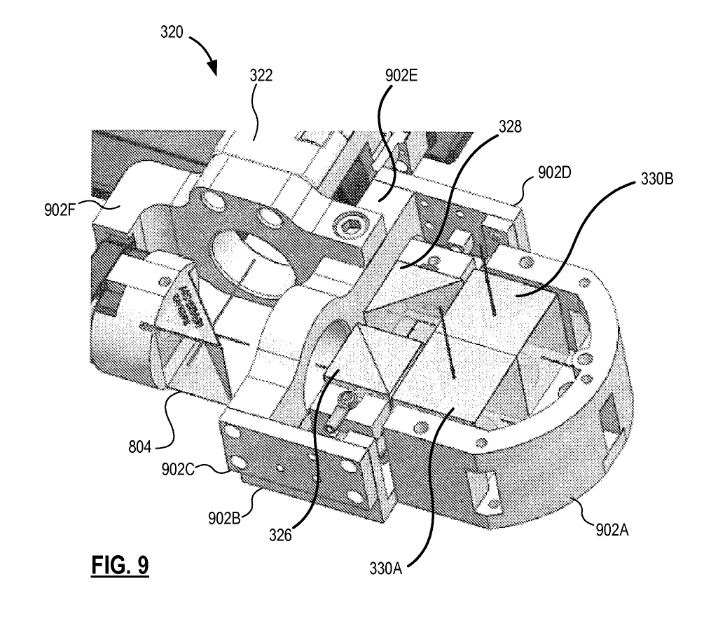

In some embodiments, the projection system 320 may be provided as a kit configured to retrofit an existing microscope. Accordingly, the projection system 320 may be provided in a housing, as shown in FIG. 9, that can be retrofitted into existing microscopes. FIG. 9 illustrates an embodiment of the projection system 320 configured within a housing 900. As shown, the housing 900 includes a plurality of housing members 902A, 902B, 902C, 902D, 902E, and 902F, referred to collectively as housing members 902. The housing members 902 may be coupled together using bolts, screws, adhesives, or other attachment means known to those in the art. In some embodiments, one or more of the housing members 902 may be integrated together. For example, the housing members 902 may be formed from a single, integrated piece of material, such as metal or plastic. As shown, the projected image source 322 is affixed to the housing member 902F by a plurality of attachment mechanisms. In the embodiment illustrated in FIG. 9, the projected image source 322 is disposed at an angle relative to the path between the beam splitter 326 and the beam coupler 330A. In other embodiments, the housing member 902F may be configured such that the opening therein is aligned with the beam splitter 326 and the beam coupler 330A.

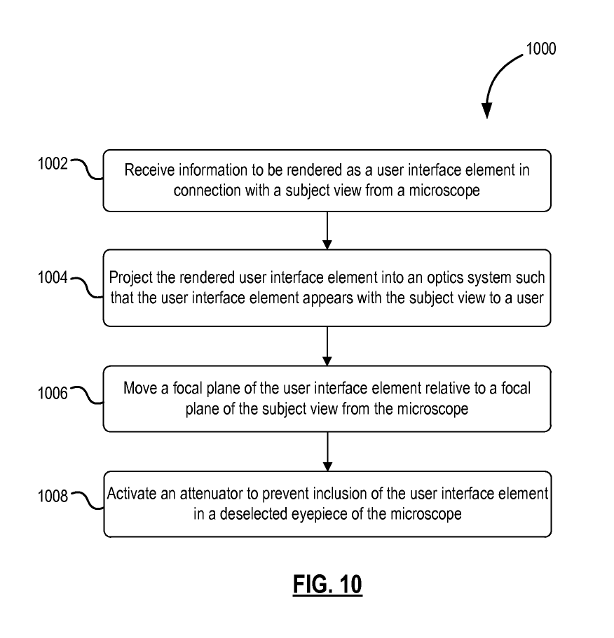

Referring now to FIG. 10, shown therein is a method 1000 of providing an adjustable projected image focal plane to a user of a microscope, like the microscope 130. The method 1000 is illustrated as a series of enumerated steps or operations. Embodiments of the method 1000 may include additional operations before, after, in between, or as part of the enumerated operations. Additionally some embodiments of the method 1000 may not include all of the operations enumerated in FIG. 10. Some embodiments of the method 1000 may include a set of instructions, stored on a non-transitory computer-readable medium, that when executed by a processing device or of a surgical system, like the surgical system 100 with the computer system 103, cause the system to perform the operations enumerated in FIG. 10.

Embodiments of the method 1000 may begin at step 1002 in which a processing device, such as a processor of the computer system 103, receives information to be rendered as a user interface element in connection with a subject view from a microscope. For example, the computer system 103 may receive or generate information comprising user interface elements for the display of information pertinent to a surgical operation through the eyepieces 304 of the microscope 130 described herein. The displayed information may include presenting a graphical user interface with interactive user interface elements, such as buttons, whereby the surgeon may manipulate one or more settings of the surgical system 100 or may request operating status information or physiological information for display. An example of such user interface elements is provided in FIG. 7, as described herein.

At step 1004, the processing device may project a rendered user interface element or image into an optic system such that the user interface element appears with the subject view to a user. For example, the processing device may communicate with the projected image source 322, which may include an image processor, which thereafter emits light including the user interface element or elements. The projected imaging source 322 directs the light to a beam splitter 326, which splits the light into to projected image paths 400A and 400B. Beam couplers 330 may be used to introduce the light of the projected image paths 400A and 400B, into a subject image path 306 obtained through a set of optical components, such as lenses 302, and directed into eyepieces 304.

At step 1006, the processing device may move a focal plane of the user interface element relative to a focal plane of the subject view from the microscope. For example, the processing device may communicate with an adjusting component, like the kinematic controller 134 may be used to direct to the kinematic mount 136, to adjust the adjustable optical component 328. The adjustable optical component 328 may include a directable optical surface 329, such as a mirror, that causes the projected image path 400B to deviate from a path parallel to the projected image path 400A. The deviation may be interpreted by the visual cortex of the user such that the projected image appears to be at a different focal plane than the subject being viewed through the microscope 130. The processing device may communicate with the kinematic controller 134 to move the adjustable optical component 328 in any of a combination of three, four, five, or six degrees of freedom to adjust the projected image plane. In some embodiments, the beam splitter 326 may be additionally or alternatively adjusted and reoriented by a kinematic mount to redirect the projected image path 400A. Accordingly, both the projected image paths 400A and 400B may be controlled to achieve a desired angle in some embodiments.

At step 1008, the processing device may activate an attenuator to prevent or limit inclusion of the user interface element in a deselected eyepiece of the microscope. For example, the processing device may communicate with the attenuator 802A to prevent or decrease the amount of light in the projected image path 400A such that the projected image appears to the surgeon only in the eyepiece 304B. For example, the surgeon may know that the surgeon's dominant eye is his or her right eye, and may select request that the projected image be displayed to his or her dominant eye. In some embodiments, the surgeon may request that the projected image be displayed to his or her non-dominant eye. In yet other embodiments, an eye tracking tool may be used to determine the dominant eye of the surgeon and automatically adjust the attenuators 802 accordingly.

Through use of principles described herein, a user can have a better experience when viewing the surgical site. Specifically, the user may be less distracted by a display of user interface elements overlaid on a subject view of a microscope. Rather, the surgical data overlay will be displayed on a focal plane that is different from that of the microscope. In this way, interactive user interface elements, such as start and stop buttons may be manipulated when a surgical tool is lifted up away from the surgical site to a projected image plane. The user may also be able to individually adjust the intensity of left and rights paths or channels of a projected image being inserted into the subject viewing path of a stereoscopic microscope.

Persons of ordinary skill in the art will appreciate that the embodiments encompassed by the present disclosure are not limited to the particular exemplary embodiments described above. For example, while a single adjustable optical component is illustrated in the depicted embodiments, other embodiments may include adjustable optical component in both project image paths. In such embodiments, a surgeon or a computer may select which project image path should be adjusted. Additionally, in some related embodiments, both adjustable optical components may be adjusted to provide a project image on a plane that is different from the subject image plane of the microscope.

In that regard, although illustrative embodiments have been shown and described, a wide range of modification, change, and substitution is contemplated in the foregoing disclosure. It is understood that such variations may be made to the foregoing without departing from the scope of the present disclosure. Accordingly, it is appropriate that the following claims be construed broadly and in a manner consistent with the present disclosure.

What is claimed is:

1. An optical system configured to display a composite image, the optical system comprising:
at least two eyepieces through which the composite image is viewable to a user;
a lens system arranged to permit viewing of a subject image in a subject image plane viewable through the at least two eyepieces; and
a projection system that overlays a projected image onto a projected image plane, viewable through the at least two eyepieces, to include the projected image and the subject image in the composite image, the projection system comprising an adjustable optical component, wherein a position of the projected image plane is adjustable relative to the subject image plane by adjustment to the adjustable optical component.

2. The optical system of claim 1, wherein the projection system further includes:
a projected image source that generates light of the projected image;
an optics component including a lens or a filter to alter the light;
a beam splitter that divides the light into multiple paths; and
a beam coupler configured to combine the multiple paths of the light of the projected image with the subject image to generate the composite image.

3. The optical system of claim 2, wherein the lens system comprises one or more microscope lenses positioned between the subject image plane and the beam coupler.

4. The optical system of claim 1, wherein the adjustable optical component comprises a mirror.

5. The optical system of claim 1, further comprising an adjusting component coupled to the adjustable optical component to permit that adjustable optical component to be adjusted to move the projected image plane relative to the subject image plane.

6. The optical system of claim 5, wherein the adjusting component permits the adjustable optical component to rotate about one or more of an x-axis, a y-axis, and a z-axis.

7. The optical system of claim 6, wherein the adjusting component comprises a kinematic mount that permits the adjustable optical component to tilt and to swivel.

8. The optical system of claim 5, wherein the adjusting component comprises one or more servos coupled to a controller to enable electronic control of the adjustable optical component.

9. The optical system of claim 2, further comprising an attenuator disposed between the subject image plane and the beam coupler that couples the projected image and the subject image, the attenuator adjusting an intensity of the projected image relative to the subject image.

10. The optical system of claim 9, wherein the attenuator comprises: a mechanical shutter, an LCD shutter, or an optical filter.

11. A microscope comprising:
a left eyepiece and a right eyepiece through which a composite image is viewable to a user;
a lens system arranged to permit viewing of a subject image in a subject image plane viewable through the left and right eyepieces;
a projection system that overlays a projected image onto a projected image plane to include the projected image and the subject image in the composite image, the projection system including:
a projected image source to provide the projected image;
an adjustable optical component, wherein a position of the projected image plane is adjustable relative to the subject image plane by positioning of the adjustable optical component;
an adjusting component coupled to the adjustable optical component to enable controlled positioning of the adjustable optical component; and
a beam coupler configured to combine the subject image and the projected image in the composite image.

12. The microscope of claim 11, further comprising a control system coupled to the adjusting component, the control system configured to receive electronic signals and adjust positioning of the adjustable optical component to adjust a location of the projected image plane relative to the subject image plane.

13. The microscope of claim 11, further comprising an attenuator disposed between the projected image source and the beam coupler.

14. The microscope of claim 13, further comprising an additional beam coupler and an additional attenuator.

15. The microscope of claim 14, wherein an attenuator control system permits a user to adjust the attenuator and the additional attenuator to include the projected image in the left eyepiece only, the right eyepiece only, or in both the left eyepiece and the right eyepiece.

16. A projection system comprising:
a projected image source to insert a projected image into a subject image path;
a beam splitter to split the projected image into a left eyepiece projected image along a left projected image path toward a left eyepiece and a right eyepiece projected image along a right projected image path toward a right eyepiece;
an adjustable optical component, wherein a position of a projected image plane relative to a subject image plane is adjustable by positioning of the adjustable optical component;
an adjusting component coupled to the adjustable optical component to enable controlled positioning of the adjustable optical component; and
a left beam coupler and a right beam coupler to combine at least one of the left eyepiece projected image and the right eyepiece projected image into the subject image path to generate a composite image.

17. The projection system of claim 16, wherein the composite image comprises a left side composite image and a right side composite image.

18. The projection system of claim 16, wherein the adjustable optical component introduces an asymmetry between the right eyepiece projected image and the left eyepiece projected image.

19. The projection system of claim 16, further comprising:
a first attenuator between the beam splitter and the left beam coupler; and
a second attenuator between the adjustable optical component and the right beam coupler.

20. The projection system of claim 19, wherein an attenuator control system permits a user to adjust the first attenuator and the second attenuator to selectively include the projected image in only one side of the composite image or in both sides of the composite image.
